(19) United States
(12) Patent Application Publication
(10) Pub. No.: US 2009/0319361 A1
(43) Pub. Date: Dec. 24, 2009

(54) WEB-BASED COMMUNICATION SYSTEM

(76) Inventor: Paul Conrady, Edmond, OK (US)

Correspondence Address: DUNLAP CODDING, P.C., PO BOX 16370, OKLAHOMA CITY, OK, 73113, US

(21) Appl. No.: 12/484,875

(22) Filed: Jun. 15, 2009

Related U.S. Application Data
(60) Provisional application No. 61/061,476, filed on Jun. 13, 2008.

(51) Int. Cl. G06Q 99/00; G06F 15/16; G06Q 20/00; G06Q 40/00; G06Q 50/00

(52) U.S. Cl. 705/14.26; 709/204; 705/44; 705/39

(57) ABSTRACT

A web-based system for automatically distributing information received from information providers to information recipients who collectively comprise a defined group of anonymous subscribers within a distribution region defined by a geographical boundary. The system uses e-mail and the Internet to communicate with compatible hardware devices. It comprises (a) at least one information server for storing and dispensing information; (b) means for allowing an anonymous information provider to upload information to the at least one information server which is stored therein as data according to the geographical distribution region; and (c) means for simultaneously communicating the uploaded information immediately after it has been uploaded to said subscribers in that distribution region.

### CROSS-REFERENCE TO RELATED APPLICATIONS

The present patent application claims priority to the provisional patent application identified by U.S. Ser. No. 61/061,476 that was filed on Jun. 13, 2008, the entire content of which is hereby incorporated herein by reference.

### STATEMENT REGARDING FEDERALLY SPONSORED RESEARCH OR DEVELOPMENT

Not Applicable.

### Reference to Sequence Listing, a Table, or a Computer Program Listing Compact Disc Appendix

Not applicable.

### BACKGROUND OF THE INVENTION

The present invention relates to a web-based communication system, and, more particularly, to a system for automatically disseminating information on crimes and other suspicious activity to registered subscribers within a given geographical area, e.g., a zip code area, wherein the information providers and the information recipients can remain anonymous.

The way in which people communicate with each other is changing. More and more, people are communicating via their personal computers, text messaging on their cellular phones, and via hand-held personal digital assistants (PDA's). Web-based news is replacing printed newspapers, and every news medium is challenged to produce broadcasts having content that attracts and appeals to a broad base of viewers. In the face of such change, there is a need to quickly disseminate information relating to regional criminal and other suspicious activity, e.g., observed suspicious behavior within a postal zip code, to people in that region who desire to be informed.

Further, as part of security systems for homes and businesses, it is common to include one or more video cameras directed at one or more predetermined object, such as a storefront, road or the like. The video content received from the video camera is usually stored locally and is not publicly available. So, assuming that a robbery takes place in down the street from one of these video cameras, the person whose home was robbed does not have access to the video content collected by the video cameras.

There is a need for a system that can get relevant information into the hands of a desired target audience of subscribers quickly while maintaining the anonymity of the subscribers, i.e., providers and recipients, comprising the audience.

### SUMMARY OF THE INVENTION

The present invention is a web-based system for automatically distributing information received from information providers to information recipients who collectively comprise a defined group of anonymous subscribers within a distribution region defined by a geographical boundary. The system uses e-mail and the Internet to communicate with compatible hardware devices. It comprises (a) at least one information server for storing and dispensing information; (b) means for allowing an anonymous information provider to upload information to the at least one information server which is stored therein as data according to the geographical distribution region; and (c) means for simultaneously communicating the uploaded information immediately after it has been uploaded to said subscribers in that distribution region.

The web-based system of the invention further comprises means for receiving an information request from a subscriber who desires a particular kind of information, means for searching data stored in the information server(s) and retrieving information requested by the subscriber, and means for sending retrieved information to the subscriber.

According to another embodiment, the present invention is a method for automatically distributing information received from anonymous information providers, i.e., “tipsters”, to information recipients who comprise a defined group of anonymous subscribers within a distribution region defined by a geographical boundary which comprises organizing information received from anonymous information providers and storing it as data on at least one information server, but also simultaneously communicating, i.e., disseminating, the uploaded information immediately after it has been uploaded to the subscribers that reside in that geographical distribution region.

The method also embraces the functions of receiving an information request from a subscriber who desires a particular kind of information, searching data stored in the information server(s), retrieving information requested by the subscriber, and then sending the retrieved information to the subscriber.

Information relating to criminal and other suspicious activity that has been uploaded into the system by an anonymous information provider may be “pushed” onto an information recipient, but only where that recipient is a current subscriber in the system. Uploaded information is maintained in the one or more information servers according to its relevance to a given geographical region, e.g., a postal zip code, and it is automatically disseminated to those subscribers who reside in that same zip code. In addition, information may also be provided to a subscriber in response to a specific request from that subscriber. An information request may be made by a subscriber via a web browser interface on the Internet, by sending an email to the system, or by sending a text message, such as, for example, a short message service (SMS) message to the system requesting a certain kind of information within a given geographical region. Desired information is retrieved from a database of such information according to geographical region and/or search words used in a query. The information, which may comprise text as well as videos and photographs, may have been uploaded by any one of a number of anonymous providers. It is then sent anonymously to the subscriber making the request.

In another embodiment, the present invention is directed to a method for distributing information publicly via the Internet, comprising the steps of: (i) registering information from information providers with at least one information server with at least part of the information identifying video cameras directed at predetermined objects, and the location of the video cameras; (ii) receiving and organizing video content from the video cameras and storing it as data on at least one information server; (iii) receiving selections from subscribers who desire video content from particular ones of the video cameras; (iv) sending retrieved video content information to the subscribers. Optionally, the location of the video cameras can be displayed on a map and indicated by a marker, whereupon step (iii) can include the step of selecting the marker as part of the selections received from the subscribers. The predetermined objects can be roads storefronts or the like. Optionally, the information server can be accessible to the subscribers via a web server identified by a URL.

In yet another version, the present invention is directed to a method for distributing information publicly via the Internet, comprising the steps of: (i) registering information from information providers with an information server with at least part of the information identifying video cameras directed at predetermined objects, the location of the video cameras and contact information for the information providers; (ii) receiving selections from subscribers who desire video content from particular ones of the video cameras; and (iii) sending the contact information for the information providers to the subscribers desiring video content from particular ones of the video cameras. The predetermined objects can be a storefront, road or the like. Optionally, the information server is accessible to the subscribers via a web server identified by a URL.

It should be understood that the detailed description and specific examples which follow, while indicating preferred embodiments of the invention, are intended for purposes of illustration only and are not intended to limit the scope of the invention.

### BRIEF DESCRIPTION OF THE SEVERAL VIEWS OF THE DRAWING

FIG. 1 is a schematic diagram which illustrates a core concept of the system of this invention.

FIG. 2 is a schematic diagram which illustrates an alternate configuration of the system of this invention.

FIG. 2B is a schematic diagram which illustrates an overview of the system.

FIGS. 3 and 11 are exemplary home pages generated by a web server in accordance with an embodiment of the present invention.

FIGS. 4A and 12 are exemplary user registration forms generated by a web server in accordance with an embodiment of the present invention.

FIG. 4B is a flowchart of a registration process in accordance with an embodiment of the present invention.

FIGS. 5 and 14 are exemplary crime query screens generated by a web server in accordance with an embodiment of the present invention.

FIG. 6A is an exemplary screen for reporting a loss of property generated by a web server in accordance with an embodiment of the present invention.

FIG. 6B is an exemplary screen for reporting a loss of property generated by a web server in accordance with an embodiment of the present invention.

FIG. 6C is an exemplary screen for displaying information generated by a web server in accordance with an embodiment of the present invention.

FIG. 6D is a flowchart of a process for reporting information in accordance with an embodiment of the present invention.

FIG. 7 is an exemplary screen for updating a previous report generated by a web server in accordance with an embodiment of the present invention.

FIG. 8 is an exemplary screen for submitting a video generated by a web server in accordance with an embodiment of the present invention.

FIGS. 9A and 9B are exemplary screens for querying an item of interest generated by a web server in accordance with an embodiment of the present invention.

FIG. 9C is a flowchart for a process for reporting information of interest in accordance with an embodiment of the present invention.

FIG. 9D is a flowchart for a reward facilitation process in accordance with an embodiment of the present invention.

FIGS. 10A and 10B are an exemplary screen for viewing a police report generated by a web server in accordance with an embodiment of the present invention.

FIG. 11 is an exemplary home page in accordance with an embodiment of the present invention.

FIG. 12 is an exemplary screen for displaying and collecting information to become a subscriber whereby information and/or alerts can be automatically provided to the subscriber.

FIG. 13 is an exemplary screen for displaying information of interest generated by a web server in accordance with an embodiment of the present invention.

FIG. 14 is an exemplary screen generated by a web server to search for reported crimes using various criteria in accordance with an embodiment of the present invention.

FIGS. 15-18 are exemplary screens for displaying information of interest generated by a web server in accordance with an embodiment of the present invention.

FIGS. 19-21 are exemplary screens generated by a web server for implementing another version of the present invention where subscribers (information recipients) are provided access to video content captured by registered video cameras. More particularly, FIGS. 19A-B collectively show a registration screen for registering one or more of the video cameras;

FIG. 20 shows a screen of a map having tags identifying three different registered video cameras; and

FIG. 21 is an exemplary e-mail screen generated upon selection of one of the registered video cameras establishing communication between devices of an information recipient and the information provider having registered the selected video camera.

### DETAILED DESCRIPTION OF THE INVENTION

The invention described herein relates generally to a comprehensive arrangement in which information providers, who can remain anonymous, can disseminate information to subscribers within a distribution region defined by a geographical boundary. Subscribers comprise a group of registered users who also can remain anonymous, but who want to receive the subject information as soon as it becomes available. The geographical distribution region can be one or more postal zip codes, a school zone, or a corporate, city or county boundary limit, for example. Alternatively, subscribers may also request specific information from the system and receive it anonymously.

The invention(s) will be referred to herein as a “Crime Deputy system” “CD” even though the following description covers systems and methods. The “currency” of the Crime Deputy system is information. The information can be provided, for example, by citizens, governmental agencies and businesses on an anonymous basis whether or not they have joined the Crime Deputy system as “subscribers”. To receive information, one must formally register with the system, although registration can be maintained on an anonymous basis as well. The system may also provide for a log-in username and password for access as part of the registration process.

Information that subscribers desire to disseminate is stored in the form of data in one or more database(s) that may be indexed according to various keywords, subjects, geographic locations, postal zip codes, etc. Certain information uploaded into the Crime Deputy system which a subscriber or any other individual or agency deems relevant for immediate dissemination because it relates to, and is indexed to reflect, recent criminal or other suspicious activity within a given geographical region can be automatically distributed by the Crime Deputy system to subscribers anonymously within that geographical region. Further, the geographical region can be determined by using an address (or latitude and longitude of the address) of an incident and assigning a distance from the address (or latitude/longitude of the address).

Subscribers who seek information regarding recent activity in their geographical region or other information of a non-urgent nature relating to, for example, home and/or personal security products, security tips and the like, may query the database based on search words that they use in their query. The information sought might relate to previously reported criminal activity in a given zip code during a specified time frame (e.g. photographs, surveillance videos, personal accounts, incident reports, etc.), press releases, public announcements, security tips, home and personal security devices, etc.

The following definitions are set forth for clarity and efficiency.

ISP: Internet Service Provider, including any service providing access to the Internet, including dial-up networks, public networks, private networks, broadband providers, cable providers, satellite providers, fiber optic providers, ADSL, DSL, other Dial-up networks, AOL®, and the like.

PDA: Personal Digital Assistant, including Blackberry®, Palm® device, hand held pc, Bluetooth® device, and other hand-held wireless devices, etc.

Carriers: Any entity providing voice and/or data communication from point to point, including cellular systems, cable systems, packet data systems, wire line systems, satellite systems, fiber optic systems, RF systems, dial-up dedicated networks, private networks, Internet carriers, PHS, PDA networks, Blackberry® network, AOL® network, and the like.

Network: Any arrangement for carrying data among and between any entities attached to the network, including satellite networks, fiber optic networks, wired networks, local area networks, wide area networks, broadband wireless networks, and the like.

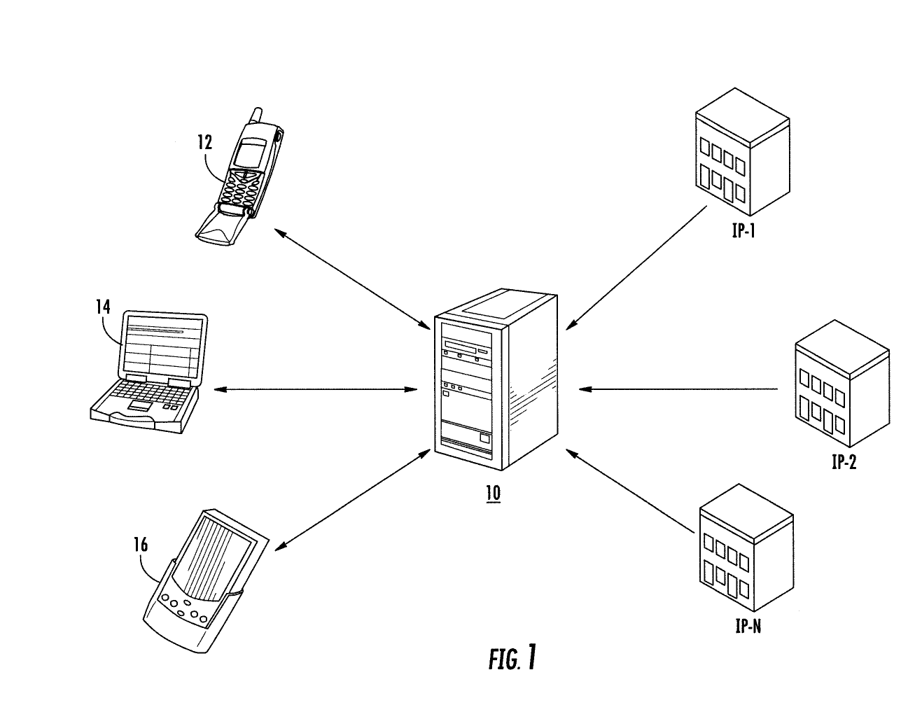

FIG. 1 is a schematic diagram which illustrates a core concept of the Crime Deputy communication system. The invention relates in general to a system, method and arrangement for collecting information received from a variety of information providers (shown by way of example in FIG. 1 as IP-1, IP-2, and IP-N) who can remain anonymous (i.e., tipsters), whether residing within or without a given geographical region. Information from the “tipsters” is received, uploaded and organized by the system in a manner that makes it accessible and searchable, and makes the information available to information recipients (IR-1, IR-2, IR-N) who have formally registered with the Crime Deputy system as anonymous subscribers and may be seeking certain information. The tips will be submitted to the police, and will preferably not notify the victim or the subscribers that a tip has been submitted.

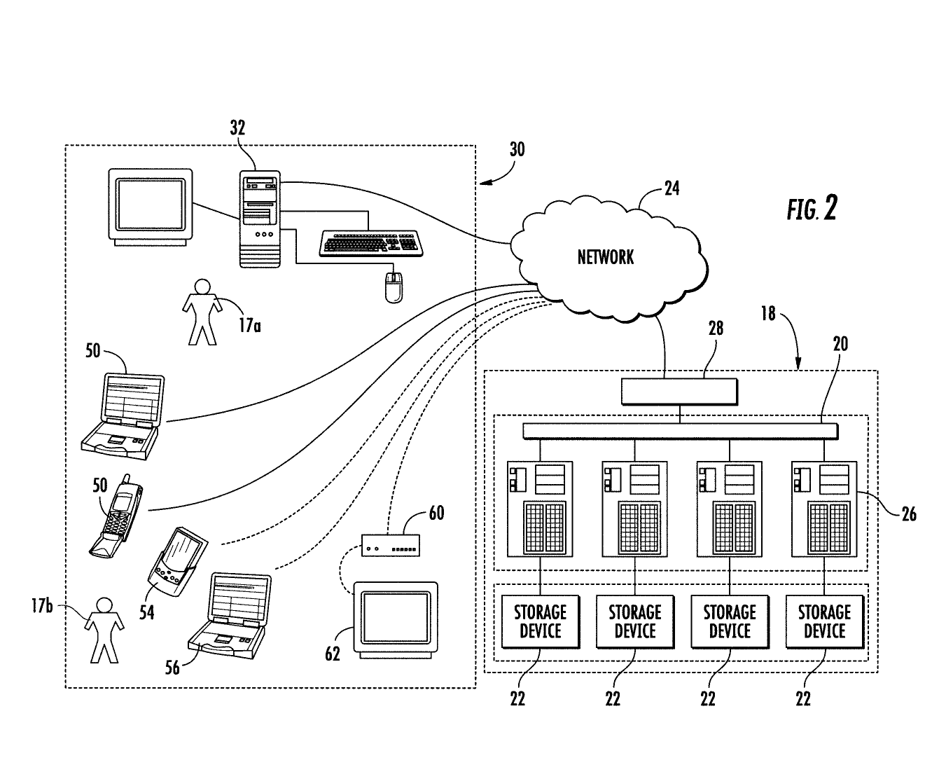

The Crime Deputy system has a server 10 that carries out multiple “server” functions. Although illustrated as a single server 10 in this figure, practical embodiments, such as will be described below, utilize multiple servers appropriately networked to communicate with each other and with all registered subscribers. A four server example is shown in FIG. 2. Multiple servers are used in part so that the system is sufficiently robust to handle a large volume of data traffic and can communicate effectively with a large number of subscribers. Server 10 includes hardware and software for carrying out server functions including: database server, web server, DNS and email server.

Means and methods are provided for communicating in a variety of modes, manners and protocols with both all registered subscribers anonymously regardless of the types of hardware devices they may be using. Pictured and represented in FIG. 1 are subscribers using a cellular device 12, a laptop computer 14 and a PDA 16, respectively, to illustrate the universal availability of the Crime Deputy system to users of different types of devices and communication methods.

Referring now to FIG. 2, shown therein and designated by reference numeral 18 is an alternative embodiment of a Crime Deputy system in accordance with the present invention. The system 18 is provided with an interface system 20 and a storage system 22. The interface system 20 allows multiple individuals 17a who are aware of the Crime Deputy system to individually enter relevant information using a variety of hardware devices. Individuals 17a, by way of example, can be governmental agencies, police departments, local citizens and others having crime and/or security related information that may be of interest to the pool of registered subscribers on the system. The information can be indexed for storage in storage system 22 according to various organization features, including subject matter categories, “keywords” and/or zip code or both, or using some other convenient coding method that are all available as search terms. Thus, inquiries from registered subscribers can be processed to locate requested information based on the system's adopted organizational features.

Third party registered users 17b, by way of example, can be the remaining pool of registered subscribers on the Crime Deputy system who are interested in keeping informed about criminal and other suspicious activity that may be occurring within their zip code or other predefined distribution region.

Various levels of subscriptions can be provided to distinguish between individual citizens, and government and non-profit agencies and businesses. A subscriber may be permitted to upload information regarding certain subjects for free, but other information, for example, as to commercial subjects available for purchase may require the subscriber, e.g., a business, to pay a fee. If you are an advertiser then your name can be mentioned in the credits.

FIG. 2 is an exemplary hardware diagram for a Crime Deputy system 18 according to the invention. The system 18 is arranged to receive and immediately communicate to all subscribers within a given geographical region certain coded information relating to current or historical criminal or other suspicious activity of interest to the subscribers. All such communications between subscribers via subscriber devices are accomplished on an anonymous basis via a network 24. Network 24 will typically be the Internet although other networks can function effectively. Interface system 20 will typically include one or more servers 26 configured to communicate with the network 24 using one or more gateways 28. When network 24 is the Internet, the interface system 20 of the Crime Deputy system will typically use a series of web pages that guide subscribers 17a and 17b through the Crime Deputy system 18 and assist them in entering and retrieving information. First-time subscribers will be guided through a registration process in which they can remain anonymous, if desired. It is anticipated that almost all subscribers will want to maintain anonymity whenever using or accessing the system. However, formal registration is not required for anyone, i.e., an anonymous tipster, who desires to enter relevant information into the system.

Network 24 can be almost any type of network, although Internet and Internet 2 networks are preferred because of the widespread support of their underlying technologies. A preferred embodiment of network 24 is an Internet environment, meaning a TCP/IP-based network, although a variety of communication modes and communication protocols can be used. As noted briefly above in reference to FIG. 1, subscribers depicted in FIG. 2 in the broadest context of the system can use a variety of devices 30 in accessing the Crime Deputy system 18, such as, for example, a personal computer 32, a laptop computer 50, cellular phone 52 with a micro or embedded Web browser, a PDA 54 or similar device, such as a Palm® device, Blackberry®, PHS device and the like capable of wireless network access, or a pen-based or notebook computer 56. Subscriber devices can also comprise a cable television box 60, or other similar device, or Web-TV for viewing through a monitor 62.

The Crime Deputy system 18 can be used to catalog specific types of incidents and reports, such as, for example, lost & found reports; scams; deadbeat parents; and missing persons. Victims can also upload reports on instances of stolen property, vandalism, offers of reward for return of missing property, etc. Communications to governmental agencies, such as police departments, can provide for read receipts being returned to the submitter.

### Example Implementation

FIG. 2B is schematic diagram of one embodiment of the crime deputy system 18. This schematic describes an overarching view of the system, starting with the home page. An individual may preferably navigate to other functions of the system, search for crime reports, crime deputies, crime victims, stolen property databases, and miscellaneous information by clicking on links associated with the home page. The details of the system will be described in greater detail infra.

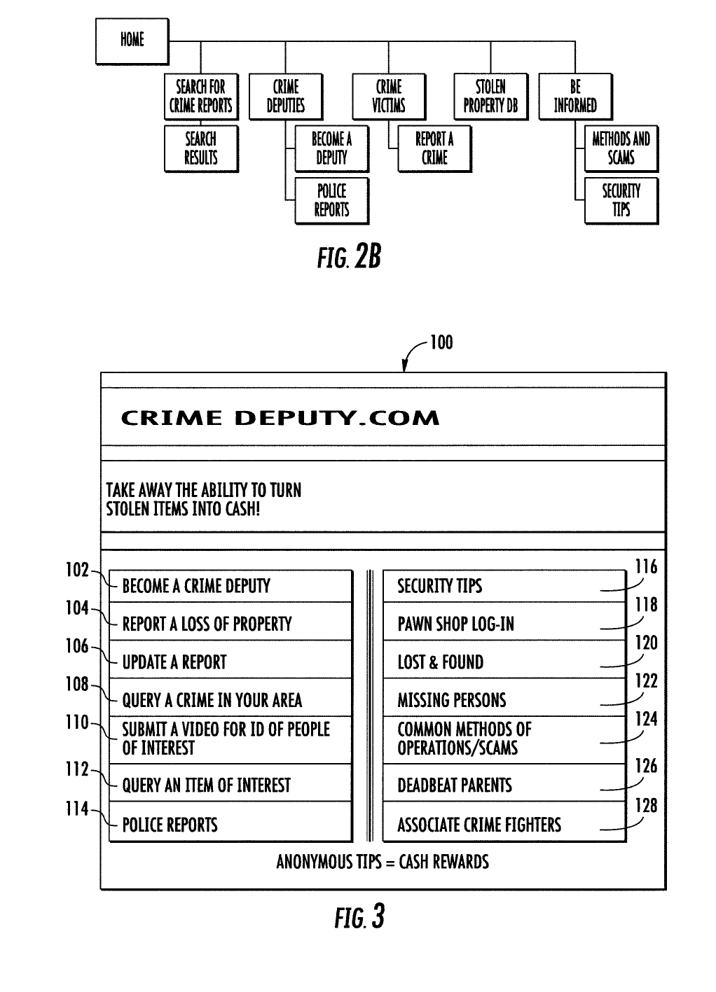

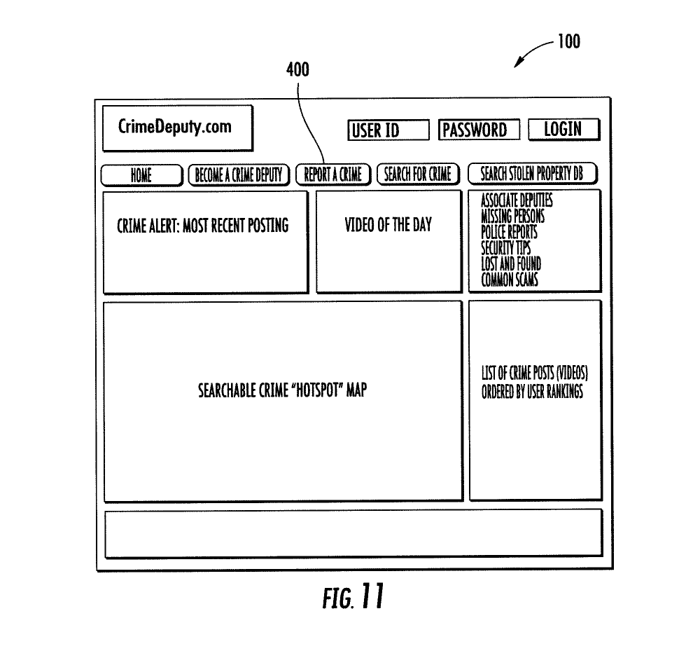

FIGS. 3-17 are exemplary web pages generated by the server 10 of the crime deputy system in accordance with an embodiment of the present invention. In particular, FIGS. 3, 4A, 5, 6A, 6B, 6C, 7, 8, 9A, 9B, 10A and 10B illustrate exemplary web pages enabling the information providers IP to anonymously upload information to the server 10 and information recipients to register with the server 10 and/or interact with the crime deputy system 18. Also, FIGS. 11-18 show alternative exemplary web pages having the same or substantially similar functionalities as the web pages illustrated in FIGS. 3, 4A, 5, 6A, 6B, 6C, 7, 8, 9A, 9B, 10A and 10B.

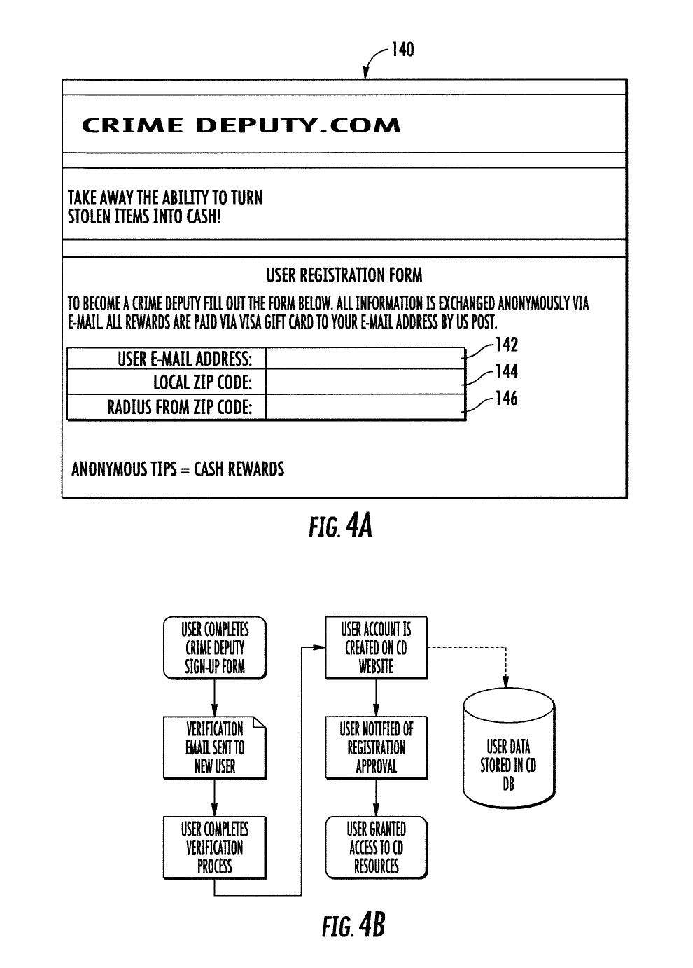

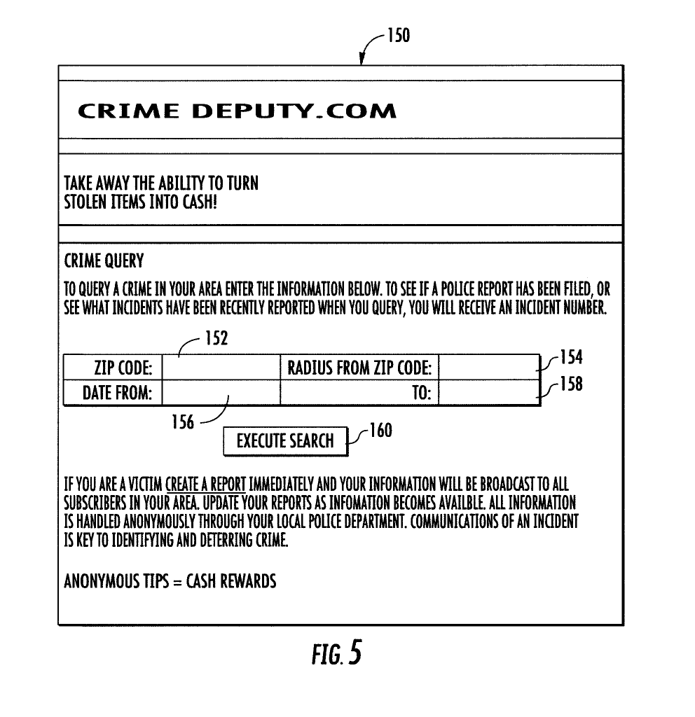

FIGS. 3 and 11 are exemplary home pages 100 that are provided with a plurality of links to the web pages shown in FIGS. 4A, 5, 6A, 6B, 6C, 7, 8, 9A, 9B, 10A, 10B, and 11-17. The links can be activated utilizing any suitable technology, such as a plurality of buttons 102, 104, 106, 108, 110, 112, 114, 116, 118, 120, 122, 124, 126, and 128. Also, FIG. 11 is shown as having button 400 for reporting a crime to the system.

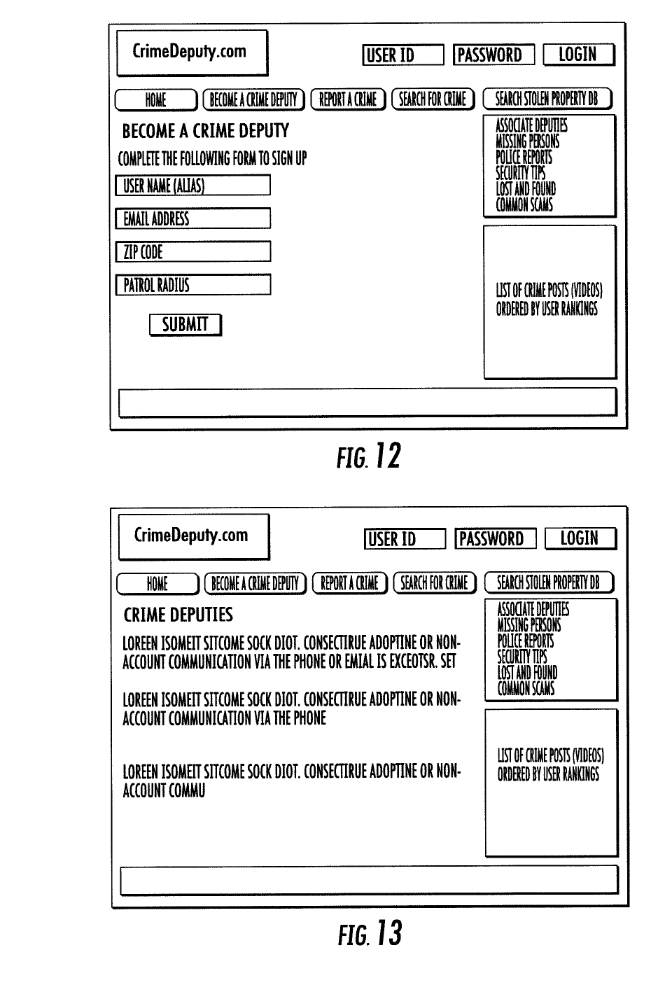

Referring now to FIGS. 4A, 4B and 12, collectively showing a registration process. When a user clicks on the button 102, the server 10 generates and transmits a user registration form 140 to the subscriber's device via the network 24. The user registration form 140 is provided with a plurality of fields 142, 144 and 146 to permit the subscriber to enter and store information on the server 10 to register anonymously with the server 10. For example, the field 142 is adapted to collect the subscriber's e-mail address, the field 144 is adapted to collect a zip code local to where the subscriber lives or works, and the field 146 is adapted to collect a radius (in any suitable units, such as feet or miles) from the local zip code to permit the subscriber to receive information that occurs outside of the geographic area identified by the local zip code.

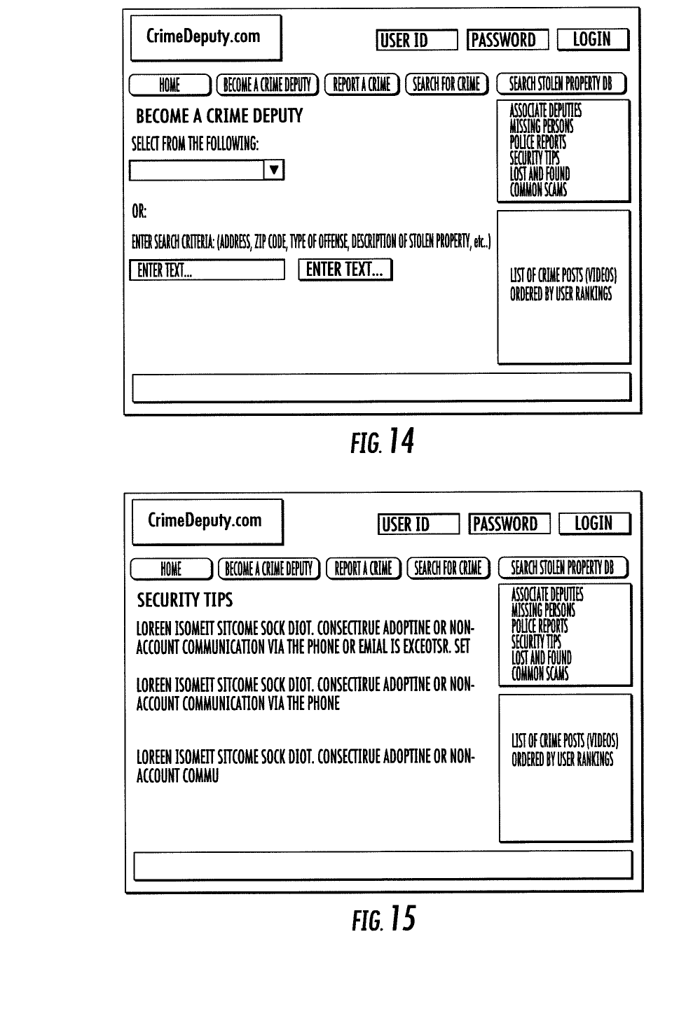

It will be understood that before an individual becomes a crime deputy, that individual may select to read information about becoming a crime deputy and further membership information. An individual may preferably click a link (not shown) on home pages 100. Clicking the link may preferably bring up crime deputy information page 500 (see FIG. 13). This page preferably comprises a section of text, audio, and/or video which comprises information regarding the membership process.

After the subscriber has entered the appropriate information into fields, 142-146, the crime deputy system 18 executes the registration process shown in FIG. 4B. The system sends a verification email to the subscriber notifying them of the initiation of the registration process. Next, the subscriber preferably responds to the verification email by responding to the verification email sent by the system. This response may include, but is not limited to, an email response, a telephonic response, a standard mail response, and/or a short message system (SMS) response. Once a response has been received by the system, the system creates a user account by populating a database entry, for example, with the information entered into fields 142-146. In one embodiment, the system may preferably send a notification (i.e. email, SMS) confirming the success and/or failure of the registration process. If the registration process is successful, the subscriber is granted access to system resources (i.e. report crimes, report tips, search crime reports, registered video cameras etc.).

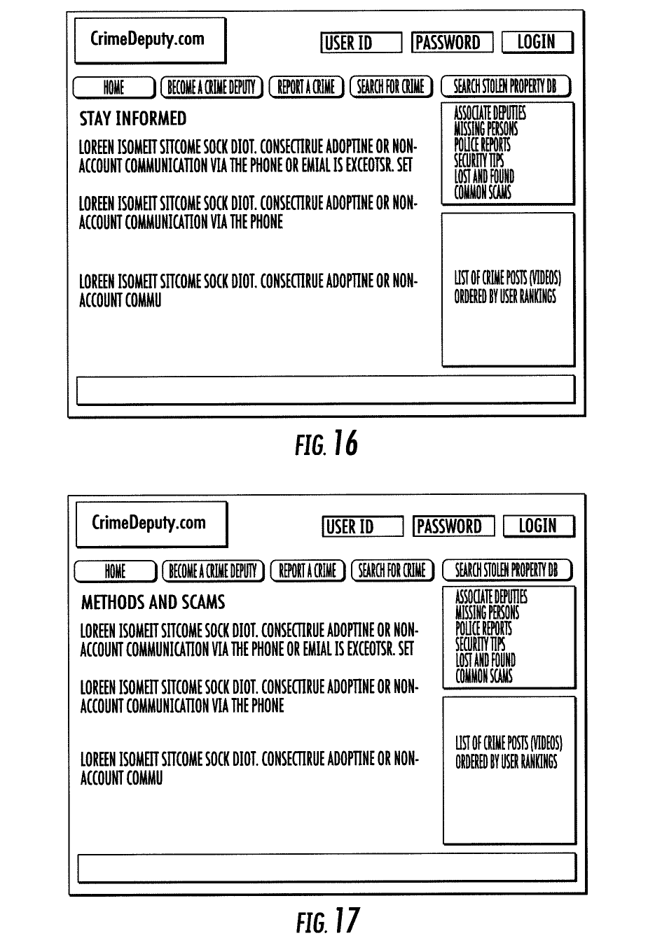

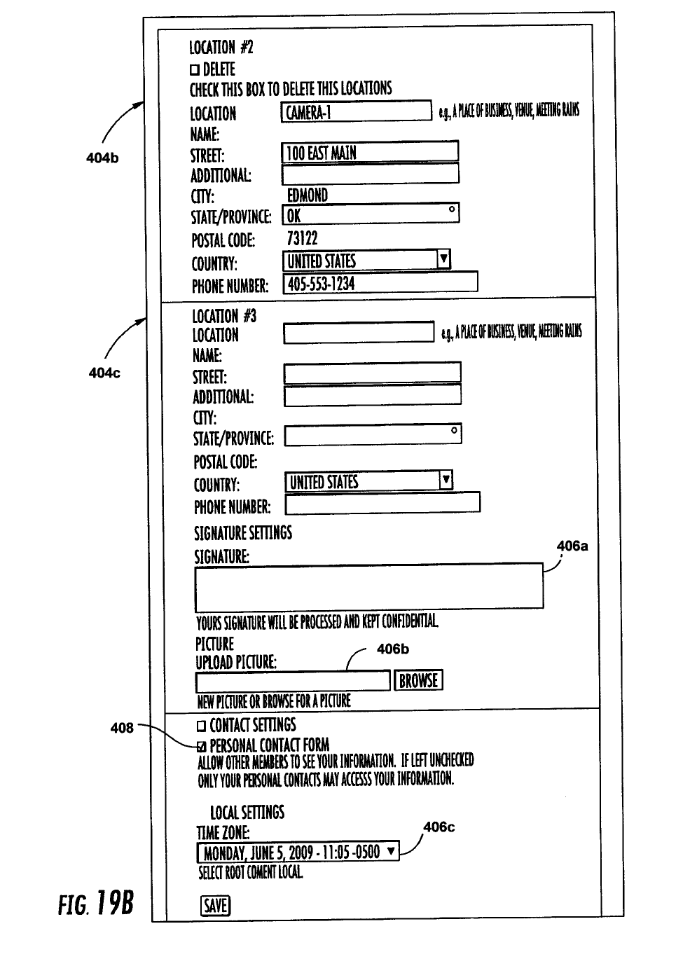

Referring to FIGS. 5 and 14, when a user clicks on the button 108, the server 10 generates and transmits a crime query screen 150 to the subscriber's device via the network 24. The crime query screen 150 is provided with a plurality of fields 152, 154, 156 and 158 to permit the subscriber to input search information for querying one or more crimes which have been reported to the server 10 and which occurred in or near a particular zip code. Once the desired search information is entered into the fields 152, 154, 156 or 158, then the subscriber selects an “execute search” button 160 to cause the server 10 to conduct a search and then to provide the search results to the subscriber, typically by generating appropriate web pages on the subscriber's device (see FIG. 18).

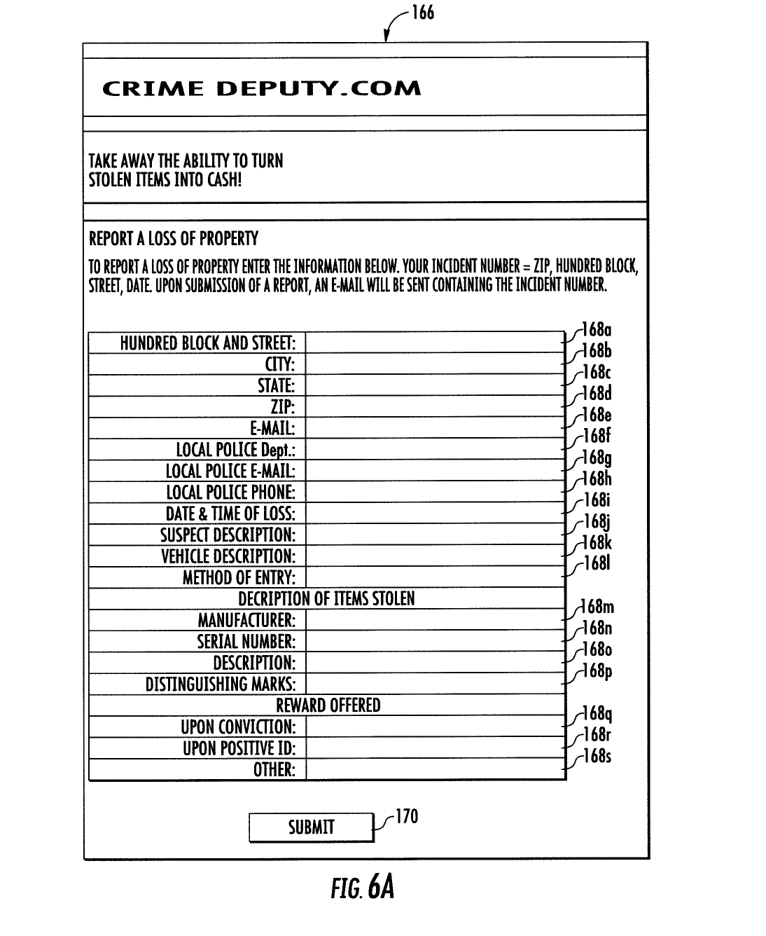

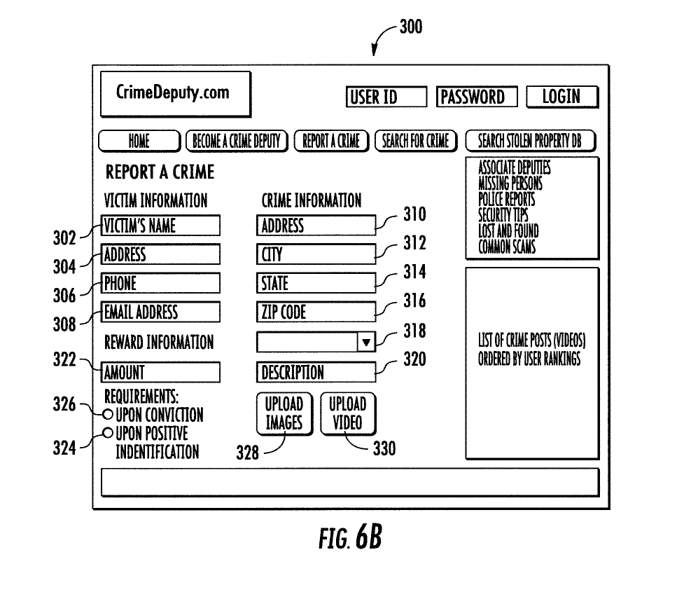

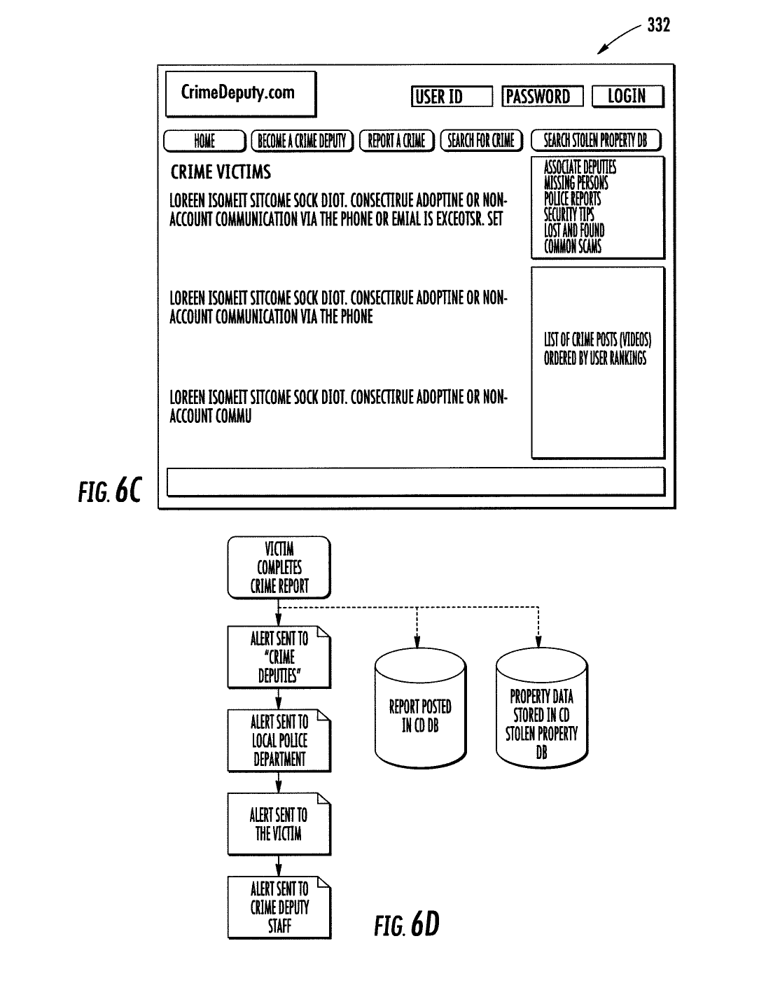

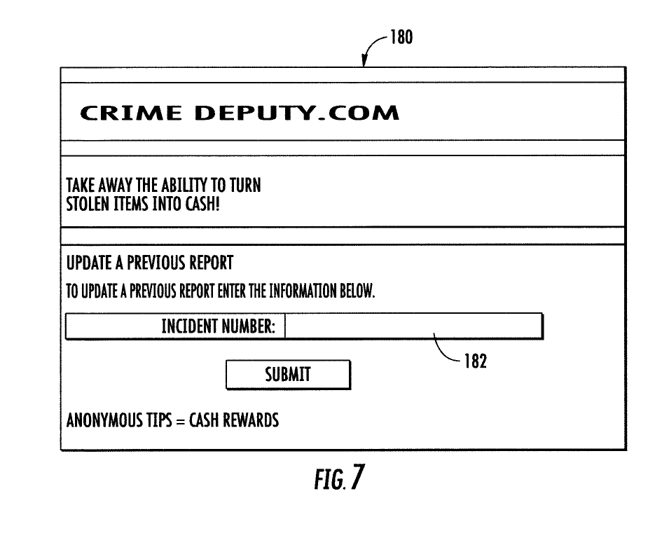

Referring to FIG. 6A, when a user clicks on the button 104, the server 10 generates and transmits a web page 166 to the subscriber's device via the network 24. The web page 166 is provided with a plurality of fields 168a-s, as well as a “submit” button 170 for permitting the subscriber to enter information regarding a loss of property to the server 10. The web page 166 can also be provided with additional fields or links 168t, 168u and 168v to permit the subscriber to upload a video, still picture(s) to the server 10, or to submit the report to a listed or local police station. Upon the subscriber entering the information regarding a loss of property to the server 10, the server 10 generates an incident identification, such as an incident number and then provides the incident identification to the subscriber utilizing any suitable method, such as by displaying the incident identification on a web page, or e-mailing the incident identification to the subscriber.

Referring now to FIGS. 6B, 6C and 6D collectively showing a process for reporting crimes. When a user clicks on the button 400 (see FIG. 11), the server 10 generates and transmits a report a crime query screen 300 to the subscriber's device via the network 24. An individual preferably inputs appropriate information (i.e. name, address, phone number, etc.) into the plurality of text input boxes 302-308. Also, the individual reporting the crime may preferably input crime details (i.e., location, city, state, zip code, etc.) into the plurality of text input boxes 310-316. Also, the user may wish to select a general crime category (i.e. burglary, car accident, suspicious behavior, etc.) by selecting a category from drop-down listbox 318. If no suitable general crime category applies, or the individual needs to add additional information, the individual may preferably input the information into text input box 320. Furthermore, the individual reporting the crime may include a reward along with the crime report. To facilitate this, the individual may preferably input a dollar amount, or description of assets into text input box 322, and may further specify the condition(s) which pertain to obtaining the reward by selecting, for example, radio button 324, or 326, although alternative methods (i.e. text input, drop-down boxes, etc.) for obtaining the condition(s) are likewise contemplated in accordance with the present disclosure. Lastly, the individual reporting the crime may preferably include images or videos to provide additional crime information to the system by clicking links 328 and 330.

To aid the individual in utilizing the report a crime query screen 300, the individual may preferably view crime victim reporting page 332 (see FIG. 6C). The individual may navigate to this page by clicking a link (not shown) on the home page 100 or another link associated with the report a crime query screen 300. This page preferably describes the crime reporting process to aid the individual in both understanding the reporting process and in completing the various fields of the report a crime query screen 300.

After the subscriber has entered the appropriate information into the various fields, of the report a crime query screen 300, the crime deputy system 18 executes the registration process shown in FIG. 6D. The crime deputy system 18 preferably stores the information which was input into the various fields, of the report a crime query screen 300 in a database associated with server 10. Next, the crime deputy system 18 sends the crime information to the appropriate police department, and an alert is sent to the victim of the crime. It will be understood that the victim of the crime and the individual reporting the crime may not be the same individual. Also, an alert is sent to the crime deputy system 18 staff.

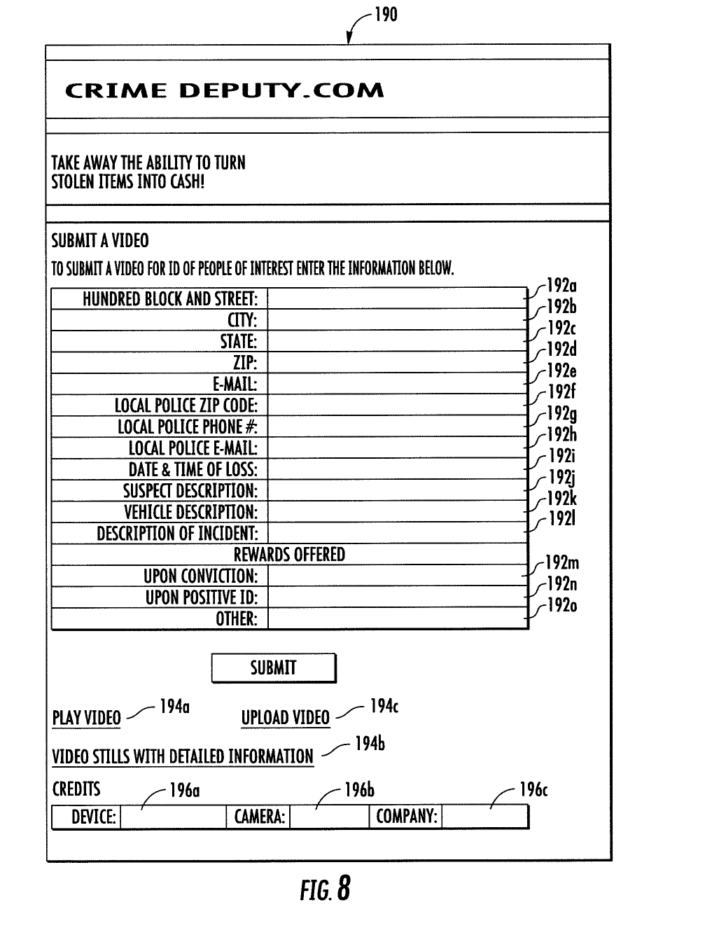

Referring to FIG. 7, to update a previous incident report, the subscriber clicks on the button 106 to cause the server 10 to generate and transmit a web page 180 to the subscriber's device via the network 24. The web page 180 is provided with a field 182 for collecting the incident information and then brings up a suitable web page (not shown) to permit the subscriber to update the previous incident report.

Referring to FIG. 8, when a user clicks on the button 110, the server 10 generates and transmits a web page 190 for submitting a video to the server 10. The web page 190 is provided with a plurality of fields 192a-o for submitting information indicative of the address where the incident occurred (see fields 192a-192d), an e-mail address of the subscriber submitting the video, contact information for the local police, date and time of loss, suspect description, vehicle description, description of the incident and any rewards that are offered by the subscriber. The web page 190 preferably will not include the e-mail address field 192e so as to reduce the likelihood of direct contact between the information provider and a tipster. One or more rewards can be offered by the subscriber, and in the example shown three fields 192m-o are provided to permit the subscriber to enter in one or more rewards. The web page 190 can also be provided with a variety of links 194a-c to permit the subscriber to upload the video, play the video or view still frames of the video. In addition, other data fields 196a-c and/or links (not shown) can be provided to permit the subscriber to provide attribution to those companies or people involved in the taking of the video. For example, the manufacturer, seller or distributor of the equipment that took the video, or the name of the security company that installed and/or maintained the equipment can be entered into the data fields 196a-c. The system 18 may provide lists of authorized companies that attribution can be provided to. For example, the system 18 may limit the possibility of attribution to advertisers on the system 18.

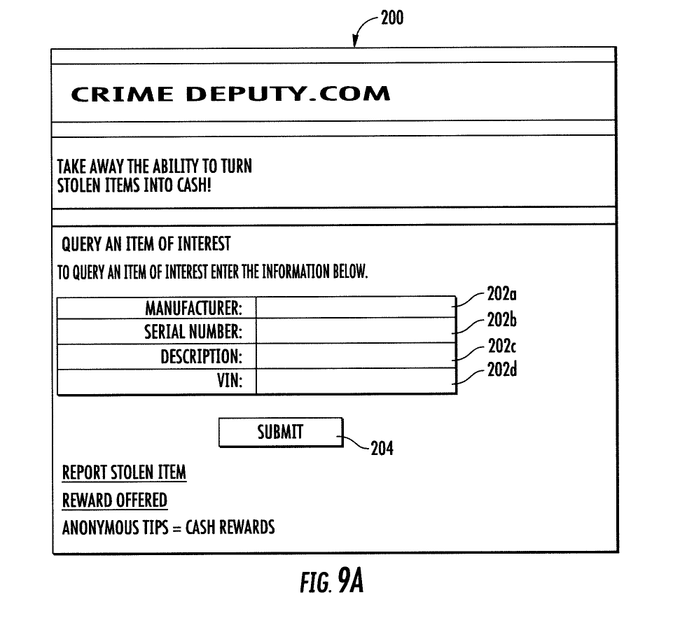

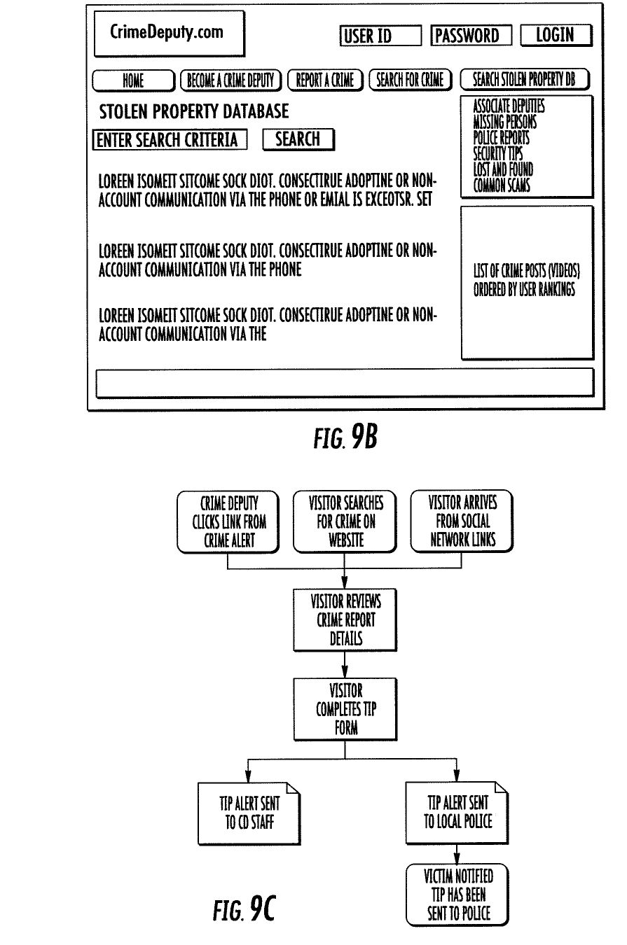

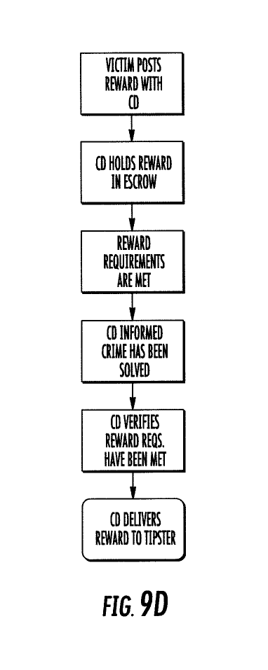

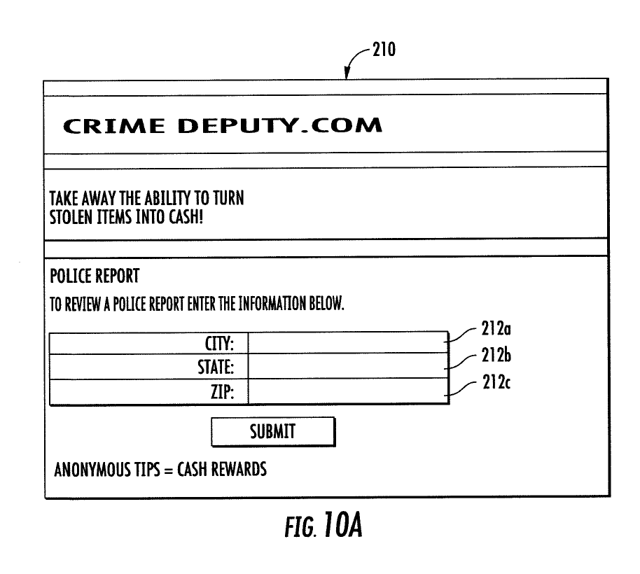

Shown in FIGS. 9A and 9B are query web pages 200 constructed in accordance with the present invention to help locate stolen property. The query web page 200 is generated when a user clicks on the button 112 on the home page 100. The query web page 200 is provided with a plurality of fields 202a-d which collect information indicative of the identity of a piece of property. For example, the manufacturer of the property can be entered into the field 202a, the serial number of the property can be entered into the field 202b, a description of the property can be entered into the field 202c, and a vehicle identification number can be entered into the field 202d. The query web page 200 is also provided with a submit button 204 to submit the query to the server 10. The server 10 can provide the search results to the subscriber in any suitable way, such as by generating a web page (not shown) containing the search results. The query web page 200 can also be provided with a plurality of links or buttons to permit the subscriber to report the stolen item to the server 10, and/or the local police; or to offer a reward for such stolen property.

Referring now to FIG. 9C, a flowchart of a tipster process is shown. In accordance with the present disclosure, the system may preferably comprise a tipster process. The first step of the process begins when a crime deputy clicks a link on a crime alert, or when an individual searches for a crime report in the crime deputy system 18, and/or when an individual is navigated to the crime deputy system from a link outside the system (i.e. a Yahoo link, a Google link, etc.). Next, the individual reviews crime report details and completes a tipster form. Although not shown, the tipster form may comprise forms as seen in FIGS. 6B, 9A, and 10A. Next, the system transmits the tip to the crime deputy staff, where the tip is preferably stored in a database associated with the server 10. The tip is then evaluated and communicated to the police. Also, the victim is preferably notified that a tip has been submitted to the police, although the details of the tip are preferably kept confidential. Alternatively, the victim is not notified that a tip has been submitted to the police.

Referring now to FIG. 9D, a flowchart of a reward process is shown. In accordance with the present disclosure, the system 18 may preferably comprise a reward process. The first step in the process allows a victim and/or other individual to post a reward with the crime deputy system 18. By way of non-limiting example, this step may be performed by a traditional banking transaction where the victim may deposit funds in a bank account, although other types of financial transactions are likewise contemplated (i.e. Paypal®, credit cards, etc.). The funds deposited are held in escrow until they are released by the crime deputy system 18. It will be understood that funds may include, for example, currencies of any form, and tangible and/or intangible assets. To release the funds in escrow, reward requirements must be substantially fulfilled. For example, an individual depositing funds may request that the funds be dispersed when a certain individual is apprehended, or a specific stolen item is recovered. In one embodiment, the crime deputy system 18 may preferably associate information pertaining to the reward deposited by an individual and the serial number of the property previously entered into the field 202b. After the crime deputy system 18 has verified that the crime has been solved (i.e. individual apprehended, item returned, etc), the crime deputy system 18 releases the funds in escrow to the tipster who provided information solving the crime.

It will be understood that although a tipster may wish to remain anonymous, in order for the tipster to receive a reward they must include some type of identification along with their tip which allows the crime deputy system 18 to associate the tipster providing the crime tip with the reward.

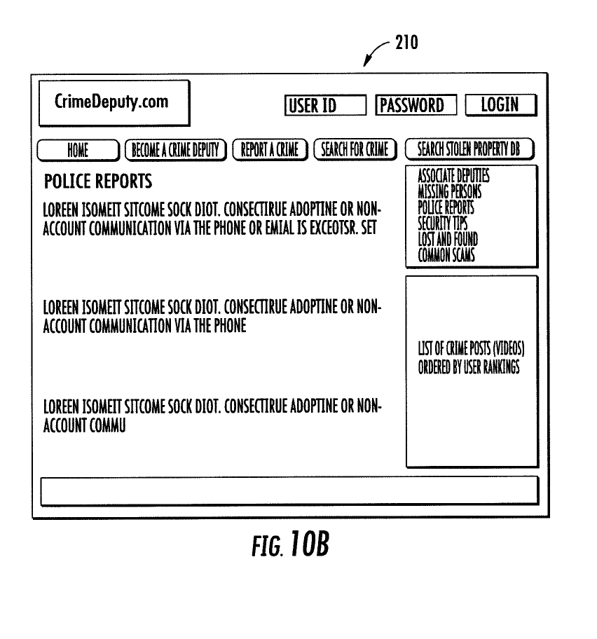

Shown in FIGS. 10A and 10B are query police report web pages 210 constructed in accordance with the present invention to permit the subscriber to view one or more police report(s). The query police report web page 210 is generated when a user clicks on the button 114 on the home page 100. The query police report web page 210 is provided with a plurality of fields 212a-c and a submit button 214. The fields 212a-c collect information indicative of the subscriber's geographical region or other geographical region so that the subscriber can query a police report database based on search words that they use in their query. For example, the fields 212a-c can collect search terms, such as city, state or zip code.

Referring again to FIG. 3, the buttons 116, 118, 120, 122, 124 126, and 128 are provided to further add additional functionality to the crime deputy system 18. In particular, such buttons 116, 118, 120, 122, 124, 126, and 128 cause additional web pages, queries, etc. to generate and transmit information accordingly. Although some of these web pages are not shown, their appearance and functionality preferably substantially resemble FIGS. 4A, 5, 6A, 6B, 6C, 7, 8, 9A, 9B, 10A, 10B, 11, 12, 13, 14, 15, 16, 17, and 18.

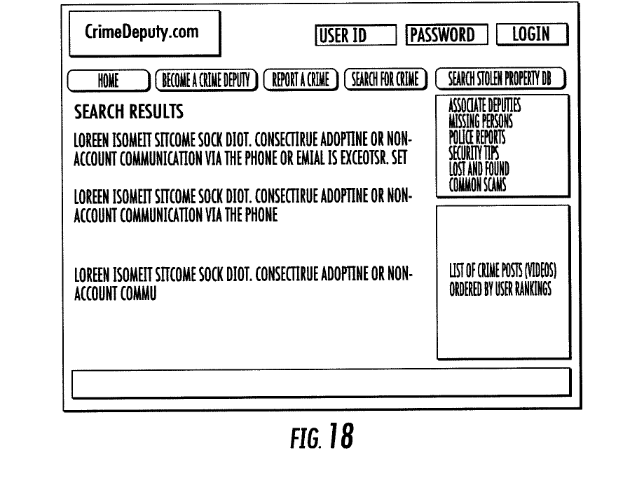

In particular, when a user clicks on the button 116, the server 10 generates and transmits a web page containing information regarding security tips (see FIG. 15). This page preferably comprises text, audio, and/or video information regarding, for example, tips for keeping your home safe while on vacation, how to protect yourself in a parking lot, or red flags to watch for when opening electronic mail. Likewise, when a user clicks on the button 118, the server 10 generates and transmits a web page which provides a graphical user interface similar to query web page 200 that allows the owners of pawn shops, or patrons of pawn shops to enter information regarding items that may have been brought into the pawn shop for sale. By way of non-limiting example, a pawn shop owner may verify that items brought in for sale are not stolen by inputting information (i.e. serial number). By clicking a submit button the query is communicated to the server 10. The server 10 can provide the search results to the subscriber in any suitable way, such as by generating a web page (not shown) containing the search results.

Also, when a user clicks on the button 120, the server 10 generates and transmits a web page which lists any items which may be lost or found, but which may not necessarily be stolen. The web page generated may preferably comprise a web page similar to query web page 200, where an individual may input information (i.e. descriptions, serial numbers, etc.) regarding items that they have either lost, or items that they have found. The web page also preferably comprises a submit button to submit the query to the server 10. The server 10 can provide the search results to the subscriber in any suitable way, such as by generating a web page (not shown) containing the search results. Also, the web page may preferably comprise a list of lost and/or found items which are displayed in varying order (e.g. chronological, alphabetical, etc.).

In one embodiment, when a user clicks on the button 122, the server 10 generates and transmits a web page which provides a list of missing persons. This list may be modified by limiting or expanding a search area by providing a zip code which is used to narrow the search area and provide only missing persons reports which have been reported to the server 10 and which occurred in or near a particular zip code. This process utilized to display missing persons reports is similar to the process utilized in FIG. 5 to query crimes.

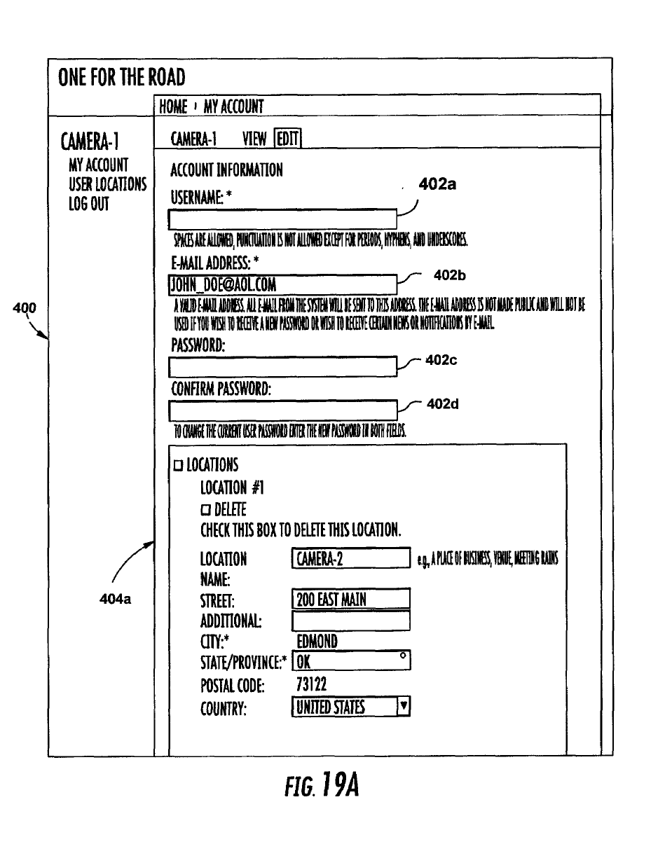

Similarly to button 116, when a user clicks on the button 124, the server 10 generates and transmits a web page containing information regarding common methods of operations and scams (see FIGS. 16 and 17). This page preferably comprises text, audio, and/or video information regarding topics such as, for example, email scams, credit card scams, and how scams are commonly perpetrated by criminals.

Lastly, when a user clicks on the button 126, the server 10 generates and transmits a web page containing information regarding deadbeat parents. This page likewise preferably comprises text, audio, and/or video information, for example, photographs or last known residence of a particular individual who is delinquent on child support, and that individual has been reported to the server 10.

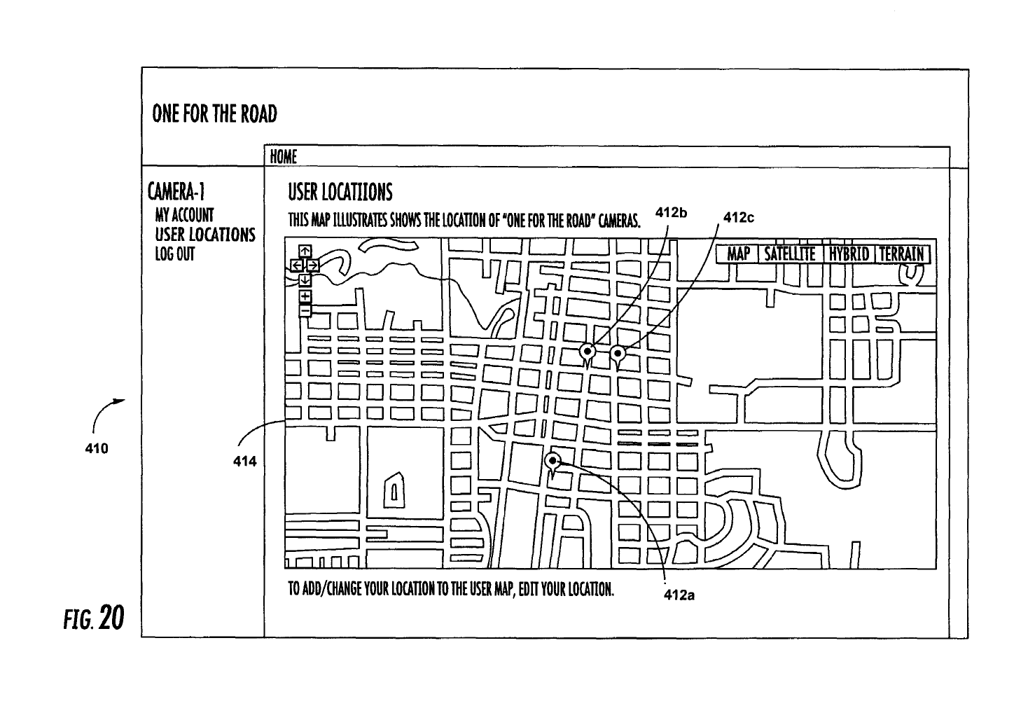

Referring to FIGS. 19A, 19B, 20, and 21, such figures show exemplary screens generated by a web server for implementing another version of the present invention where subscribers are provided access to video content captured by registered video cameras. More particularly, FIGS. 19A-B is a registration screen 400 for registering one or more of the video cameras. The registration screen 400 has fields 402a, 402b, 402c and 402d for collecting account information for the information subscribers (who may or may not be anonymous); and one or more video camera registration zone 404 (three video camera registration zones are shown in FIGS. 19A and 19B by way of example and designated by the reference numerals 404a, 404b and 404c), as well as optional subscriber information such as a signature field 406a, a subscribe picture 406b, and a local time zone field 406c. Further, the registration form can include a check box 408, or the like to provide authorization to the website to distribute the subscriber's contact information to other users or subscribers. Other details can also be included with the registration form (not shown) to identify the particular video camera and provide connection information so that video content generated by the registered video cameras is automatically or manually uploaded to the information servers 26. This can be accomplished in real-time or periodically.

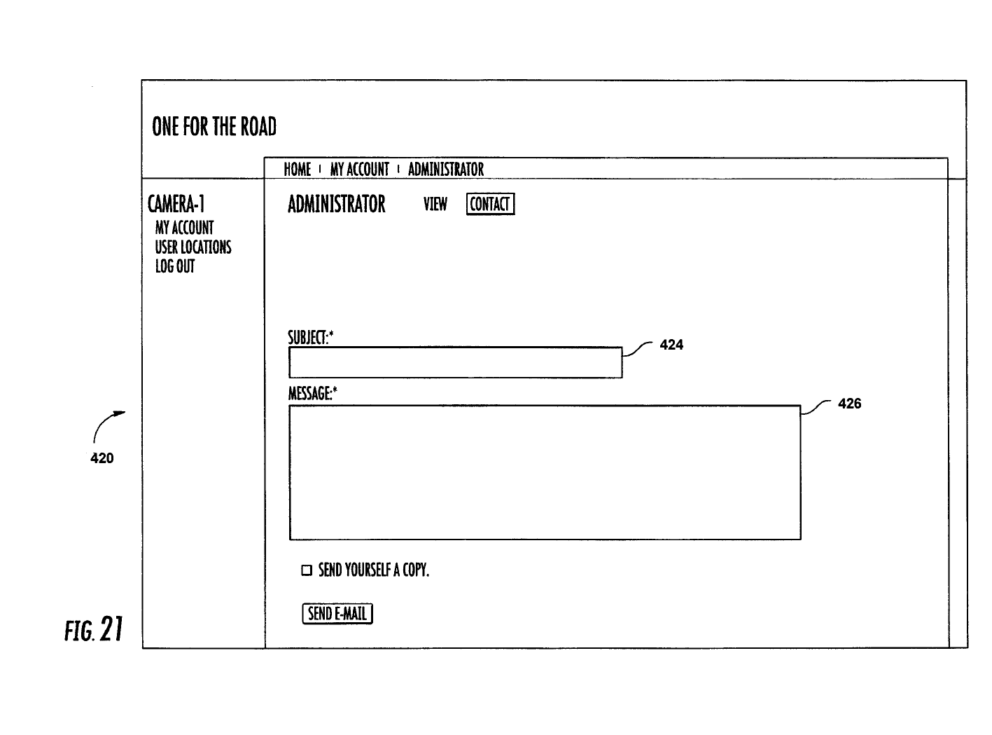

FIG. 20 shows a map screen 410 having tags 412a, 412b and 412c on a map 414. The tags 412a, 412b and 412c are positioned on the map in accordance with their actual physical location and identifying three different registered video cameras. The tags 412a, 412b and 412c can be selected (such as by a user clicking on the tags) so as to permit the subscribers to either retrieve uploaded video content from the information servers 26, or providing a communication methodology, such as e-mail or text messaging to the subscribers registering the video cameras so that the video content can be obtained directly from the subscribers. The communication methodology desirably maintains the anonymity of the subscribers.

FIG. 21 is an exemplary e-mail screen 420 generated upon selection of one of the registered video cameras (such as by selecting one of the tags 412a-c) including a subject field 424, and a message field 426 to request video content of a certain recorded time period, i.e., from 10 p.m. to 3 a.m. on June 11^{th} and 12^{th}. Each of the subscribers contact information can be maintained anonymous by having the subscribers communicate though the system 18, rather than forming direct communication where both subscribers contact information is provided. Of course, the subscribers can provide their own contact information if they want to in the message field 426.

A version of the present invention provides public access to video content captured by registered video cameras. Subscribers who seek information regarding recent activity in their geographical region or other information of a non-urgent nature relating to, for example, home and/or personal security products, security tips and the like, may query the database to locate the registered video cameras and then subsequently retrieve the video content captured by the registered video cameras, or obtain the contact information for information providers having registered the video cameras. The video content sought might relate to previously reported or unreported criminal activity in a given zip code during a specified time frame (e.g. photographs, surveillance videos, personal accounts, incident reports, etc.), press releases, public announcements, security tips, home and personal security devices, etc.

In one version, the present invention is directed to a method for distributing information publicly via the Internet, comprising the steps of: (i) registering information from anonymous information providers with at least part of the information identifying video cameras directed at predetermined objects, and the location of the video cameras (See FIGS. 19A-B); (ii) receiving and organizing video content from the video cameras and storing it as data on at least one information server; (iii) receiving selections from devices 30 of information recipients who desires video content from particular ones of the video cameras; (iv) sending retrieved video content information to the devices 30 of the information recipients.

In another version, the present invention is directed to the system 10 that includes the hardware and/or software to perform the functions described above.

The predetermined objects can be storefronts, homefronts, roads or the like. For example, the registered video cameras can be positioned at a road forming the entrance or exit of a neighborhood. Once the video camera is registered, subscribers, such as residents of the neighborhood, can access the video content captured by the video camera. This can help solve crimes by obtaining the license plate or vehicle identifications of automobiles leaving or entering the neighborhood around the time that a house within the neighborhood is broken into. Optionally, the information server is accessible to the subscribers via a web server identified by a URL.

In another version, the present invention is directed to a method for distributing information publicly via the Internet, comprising the steps of: (i) registering information from information providers with at least part of the information identifying video cameras directed at predetermined objects, the location of the video cameras and contact information for the information providers; (ii) receiving selections from devices of information recipients (e.g., subscribers) who desire video content from particular ones of the video cameras; and (iii) establishing communication between devices of the information recipient and the information provider.

As one skilled in the art will understand, the processes described above can be performed with the aid of the devices 30 and the system 18 adapted to perform the functions described above, and the resulting images, video and data are stored on one or more computer readable mediums such as the storage devices 22. Examples of a computer readable medium include an optical storage device, a magnetic storage device, an electronic storage device or the like. The term “device”, “server” or “Computer System” as used herein means a system or systems that are able to embody and/or execute the logic of the processes described herein. The logic embodied in the form of software instructions or firmware may be executed on any appropriate hardware which may be a dedicated system or systems, or a general purpose computer system, or distributed processing computer system, all of which are well understood in the art, and a detailed description of how to make or use such computers is not deemed necessary herein. When the “device”, “server” or “computer system” is used to execute the logic of the processes described herein, such device(s), server(s), or computer(s) and/or execution can be conducted at a same geographic location or multiple different geographic locations. Furthermore, the execution of the logic can be conducted continuously or at multiple discrete times. In other versions, the present invention is directed to the system 10 that includes the hardware and/or software to perform the functions described above.

From the above description, it is clear that the present invention is well adapted to carry out the objects and to attain the advantages mentioned herein as well as those inherent in the invention. While presently preferred embodiments of the invention have been described for purposes of this disclosure, it will be readily understood that numerous changes may be made which will readily suggest themselves to those skilled in the art and which are accomplished within the spirit of the invention disclosed.

What is claimed is:

1. A web-based system for automatically distributing information received from anonymous information providers to information recipients who comprise a defined group of anonymous subscribers within a distribution region defined by a geographical boundary, wherein the system uses e-mail and the Internet to communicate with compatible hardware devices, comprising:
(a) an information server for storing and dispensing information;
(b) means for allowing an information provider to upload information to the information server which is stored therein as data according to the geographical boundary; and
(c) means for simultaneously communicating the uploaded information immediately after it has been uploaded to said subscribers.

2. The web-based system of claim 1 further comprising:
(d) means for receiving an information request from a subscriber who desires a particular kind of information;
(e) means for searching data stored in the information server and retrieving information requested by the subscriber; and (f) means for sending retrieved information to the subscriber.

3. The web-based system of claim 1 wherein the uploaded information is communicated to a subscriber device selected from the group comprising a computer, a personal digital assistant, a cellular phone, and a combination personal digital assistant/cellular phone.

4. The web-based system of claim 1 wherein the geographical boundary is selected from the group comprising a zip code, an area code, a city description, a county description, and a state description.

5. A method for automatically distributing information received from anonymous information providers to information recipients who comprise a defined group of anonymous subscribers within a distribution region defined by a geographical boundary which comprises
(i) organizing information received from said information providers and storing it as data on at least one information server; and
(ii) simultaneously communicating uploaded information immediately after it has been uploaded to said subscribers in that distribution region.

6. The method of claim 4 further comprising
(iii) receiving an information request from a subscriber who desires a particular kind of information;
(iv) searching data stored in the at least one information server and retrieving information requested by the subscriber; and
(v) sending retrieved information to the subscriber.

7. The method of claim 6, further comprising the step of:
(vi) generating at least one content page via the information server, wherein the at least one content page comprises retrieved information that substantially corresponds to an information request.

8. The method of claim 6 wherein at least one of the uploaded information and the retrieved information is communicated to a subscriber device selected from the group comprising a computer, a personal digital assistant, a cellular phone, and a combination personal digital assistant/cellular phone.

9. The method of claim 7, further comprising the step of exporting, over a computer network, views of the at least one content page.

10. The method of claim 6 wherein the information request comprises at least one of: a zip code, an area code, a city description, a county description, or a geographical boundary.

11. A method for automatically distributing information, comprising the steps of: (i) receiving information from anonymous information providers;
(ii) organizing information received from said information providers and storing it as data on at least one information server; (iii) receiving an information request from a subscriber who desires a particular kind of information;
(iv) searching data stored in the at least one information server and retrieving information requested by the subscriber; and
(v) sending retrieved information to the subscriber.

12. The method of claim 11 wherein at least one of the uploaded information and the retrieved information is communicated to a subscriber device selected from the group comprising a computer, a personal digital assistant, a cellular phone, and a combination personal digital assistant/cellular phone.

13. A web-based method for distributing a reward, comprising the steps of:
(i) providing an information server for storing and dispensing at least one of a crime information and a reward information, wherein the crime information is received from an anonymous information provider and the reward information is received from an identifiable information provider;
(ii) storing at least one of a crime information and a reward information within the information server;
(iii) associating the crime information and the reward information;
(iv) receiving a reward, wherein the reward is secured in an escrow account;
(v) receiving a crime tip from an individual, wherein the crime tip is associated with a tip information provider; and
(vi) providing the reward to the tip information provider.

14. The method of claim 13, further comprising the steps of:
(vii) determining whether the crime tip is accurate;
(viii) granting access to the reward if the crime tip is accurate; and
(ix) denying access to the reward if the crime tip is inaccurate.

15. The method of claim 13, wherein the tip information provider further comprises a tip identification, wherein the tip identification allows a reward to be provided to the tip information provider that submitted the crime tip.

16. The method of claim 13, wherein the reward is selected from the group comprising a currency reward, an asset reward, and a combination currency/asset reward.

17. A method for distributing information publicly via the Internet, comprising the steps of:
(i) registering information from anonymous information providers with at least part of the information identifying video cameras directed at predetermined objects, and the location of the video cameras;
(ii) receiving and organizing video content from the video cameras and storing it as data on at least one information server;
(iii) receiving selections from information recipients who desire video content from particular ones of the video cameras;
(iv) sending retrieved video content information to the information recipients.

18. The method of claim 17, wherein the predetermined objects are roads.

19. The method of claim 17, wherein the information server is accessible to the subscribers via a web server identified by a URL.

20. A method for distributing information publicly via the Internet, comprising the steps of:
(i) registering information from information providers with at least part of the information identifying video cameras directed at predetermined objects, the location of the video cameras and contact information for the information providers;
(ii) receiving selections from information recipients who desire video content from particular ones of the video cameras; and
(iii) establishing communication between devices of information recipients and information providers having registered the selected video camera.

21. The method of claim 20, wherein the predetermined objects are roads.

22. The method of claim 20, wherein the information server is accessible to the subscribers via a web server identified by a URL.
